(19) United States
(12) Patent Application Publication
(10) Pub. No.: US 2024/0050785 A1
(43) Pub. Date: Feb. 15, 2024

(54) WEARABLE AIR PURIFICATION SYSTEM

(71) Applicant: Dyson Technology Limited, Wiltshire (GB)

(72) Inventors: Emma Victoria CARSON, Swindon (GB); Stephen Benjamin COURTNEY, Gloucester (GB); James Murray ORCHARD, Bath (GB); Thomas Scott MIDDLETON, Swindon (GB)

(73) Assignee: Dyson Technology Limited, Wiltshire (GB)

(21) Appl. No.: 18/267,763

(22) PCT Filed: Nov. 4, 2021
(86) PCT No.: PCT/GB2021/052869

§ 371 Date: Jun. 15, 2023

(30) Foreign Application Priority Data
Dec. 17, 2020 (GB) 2020008.5

(51) Int. Cl. A62B 18/08; A62B 18/00; A62B 23/02

(52) U.S. Cl. CPC A62B 18/084; A62B 18/006; A62B 18/08; A62B 23/02

(57) ABSTRACT

A wearable air purification system including a wearable support configured to be supported on a head of a user, and an air delivery mask which is shaped to bound, at least partially, an air delivery region and to deliver a flow of air to the air delivery region. The wearable support includes a left side support and a right side support which support the air delivery mask therebetween; and a left side motor and a right side motor configured to drive a respective left or right side air flow towards or away from the air delivery region, each of the left and right side motors being mounted within a respective left or right side motor housing on a respective one of the left and right side supports so that, when the wearable support is supported on the head in use, the motors sit rearward of or above the user's ears.

### TECHNICAL FIELD

The invention relates to a wearable air purification system or wearable ‘purifier’.

### BACKGROUND

Air pollution is an increasing problem in modern society with an increasing variety of pollutants having known or suspected harmful effects on humans. In areas where levels of air pollution are particularly high, or in enclosed internal spaces, many individuals have taken to wearing face masks with the aim of filtering out at least a portion of the pollutants present in the air before it reaches the nose and mouth. However, face masks are not always a good solution because breathing is restricted when wearing a face mask and, when in conversation, it can be hard to make yourself heard, and to hear what others are saying, when masks are being worn.

More sophisticated solutions make use of a wearable air purifier which can be worn on the head and include motor and filter elements. For example, one approach involves a wearable support such as a neckband or headband to which a bar-like mask or visor is attached which stretches around in front of the mouth and delivers a jet of filtered air to the wearer. Such approaches show promise over conventional fabric masks, but they tend to be bulky which can limit their practicality as an object for daily wear.

In one known example, the wearable air purifier takes the general form of a pair of headphones, and indeed can be combined into a headphone assembly with audio functionality. The headphone assembly includes one speaker assembly which is worn over a first ear of the user and another speaker assembly which is worn over a second ear of the user. One or both of the speakers includes a filter for filtering pollutants from an airflow, an impeller for creating the airflow through the filter and a motor for driving the impeller. The speaker assemblies are carried on an arcuate headband which surrounds the upper portion of the user's head in a conventional manner. Whilst such assemblies provide a more sophisticated solution than a basic face mask, for some wearers they can be uncomfortable to use and the background noise from the motor is distracting.

It is against this background that the present invention has been devised.

### SUMMARY OF THE INVENTION

According to an aspect of the present invention there is provided a wearable air purification system comprising a wearable support configured to be supported on a head of a user, and an air delivery mask which is shaped to bound, at least partially, an air delivery region and to deliver a flow of air to the air delivery region; wherein the wearable support includes a left side support and a right side support which support the air delivery mask therebetween; and a left side motor and a right side motor configured to drive a respective left or right side air flow towards or away from the air delivery region, each of the left and right side motors being mounted within a respective left or right side motor housing on a respective one of the left and right side supports so that, in use, the motors are rearward of or above the user's ears.

In some embodiments, each of the left and right side supports includes an elongate side portion which extends rearwards from the air delivery mask.

In some embodiments, the air delivery mask may take the form of an elongate bar.

If the air delivery mask and the left and right side portions are of elongate form, they may be arranged in line together so as to adopt a partial loop or full loop configuration for the device. If the elongate side portions are arranged in line with the elongate bar of the air delivery mask, a top edge of each of the elongate side portions and a top edge of the elongate bar of the air delivery mask may be aligned with one another.

By way of example, each of the left and right side supports may include an elongate side portion which extends rearwards from the air delivery mask.

In some embodiments, each of the left and right side supports includes a rear side head portion which extends over a portion of the user's head rearward of the user's ears, when the wearable support is supported on the head in use. The rear side head portion provides a protective feature for the head of the user and also provides a convenient accommodation space for other elements of the system, such as batteries and/or filters.

The wearable support may further include a support device which has first and second ends, and wherein a respective one of the left and right side supports connects with a respective one of the first and second ends, for example by means of a movable coupling. For example, the support device may be a headband which spans the top of the head in use. In embodiments, the headband may include an adjuster for adjusting the span length over the top of the head.

The first and second ends of the support device may be connected to the left and right side supports by respective movable couplings such as pivotal couplings. This allows the support device to pivot, for example, back and/or forth relative to the left and right side supports to allow the system to be moved between stowed and wearable configurations.

Each of the left and right side supports may include a respective bridge section which sits above a respective ear of the user, when the wearable support is supported on the head in use.

In some embodiments, each of the left and right side bridge sections may define a respective one of the motor housings so that the motors locate above (e.g. immediately above) a respective ear of the user, when the wearable support is supported on the head in use. However, because the motors are displaced form the ear itself, there is limited or no impact on the user of noise from the motors.

In other embodiments, each of the left and right side motor housings may be positioned remote from the air delivery region so as to locate rearward of the ears of the user when the wearable support is supported on the head in use.

The motor housings may define a gap between them at the rear of the user's head, when the wearable support is supported on the head in use.

In some embodiments, the left and right side supports may connect to one another, or are formed integrally with one another, at the rear of the user's head so as to define a closed loop structure with the air delivery mask.

In any case, positioning the left and right side motors so that they are displaced from the user's ears, leaving the ears exposed, minimises noise disturbance for the user due to the sound of the motor.

Each of the left and right side supports may include a recess which exposes a respective left or right ear of the user when the wearable support is supported on the head in use. For example, the left and right bridge sections may define, at least in part, a respective one of the recesses.

The wearable purification system may include an audio device mounted on each of the left and right side of the supports, each of the audio devices being configured to deliver audible sound to a respective ear of the user.

In some embodiments, the air delivery mask may slidably mounted relative to the left and right side supports. This permits adjustment of the size of the wearable system on the user's head, giving adaptability for those with different head shapes/sizes.

Each of the left and right motor housings may house a motor-driven impeller to deliver a respective one of the left or right side air flows to or away from the air delivery region. For example, one of the left and right side motors may be configured to drive the airflow towards the air delivery region and the other of the left and right side motors may configured to suck the air flow away from the air delivery region. Alternatively, both of the left and right side motors may be configured to drive the airflow towards the air delivery region.

The wearable purification system may include a filter associated with each of the left and right side motors for filtering the air flow. In embodiments, each filter may be located in one of the left and right side motor housings together with the associated motor, or may be located in a head portion of the associated left or right side supports (e.g. the head portion of the side support).

In any of the embodiments, the wearable purification system includes a pair of earphones including one speaker assembly which is worn over one of the ears and another speaker assembly which is worn over the other ear. However, as the motors are displaced rearward of or above the speaker assemblies, there is limited interruption of audio from the speakers assemblies due to motor noise.

In some embodiments, the wearable support includes a head portion for covering a portion of the user's upper head region. For example, the head portion may form a part of a hat, a helmet or a cap.

### BRIEF DESCRIPTION OF THE DRAWINGS

FIG. 1 is a side view of a user wearing a purification device in accordance with a first embodiment of the invention;

FIG. 2 is a section view, taken in a horizontal plane, of the wearable purification device in FIG. 1;

FIG. 3 is a perspective view of an alternative embodiment of the wearable purification device in FIGS. 1 and 2;

FIG. 4 is a side view of the wearable purification device shown in FIG. 2;

FIG. 5 is a perspective view of a further alternative embodiment of the wearable purification device;

FIG. 6 is a side view of the wearable purification device in FIG. 5;

FIG. 7 is a cross section, in a horizontal plane, of the wearable purification device in FIGS. 5 and 6;

FIG. 8 is a side view of a further alternative embodiment of the wearable purification device;

FIG. 9 is a perspective view of a further alternative embodiment of the wearable purification device, including an audio functionality in the form of headphones having speakers;

FIG. 10 is a top plan view of a further alternative embodiment of the wearable purification device, in the form of a cap;

FIG. 11 is a side view of the wearable purification device in FIG. 10;

FIG. 12 is a top plan view of a further alternative embodiment of the wearable purification device, in the form of a helmet; and

FIG. 13 is a side view of the wearable purification device in FIG. 12.

### DETAILED DESCRIPTION

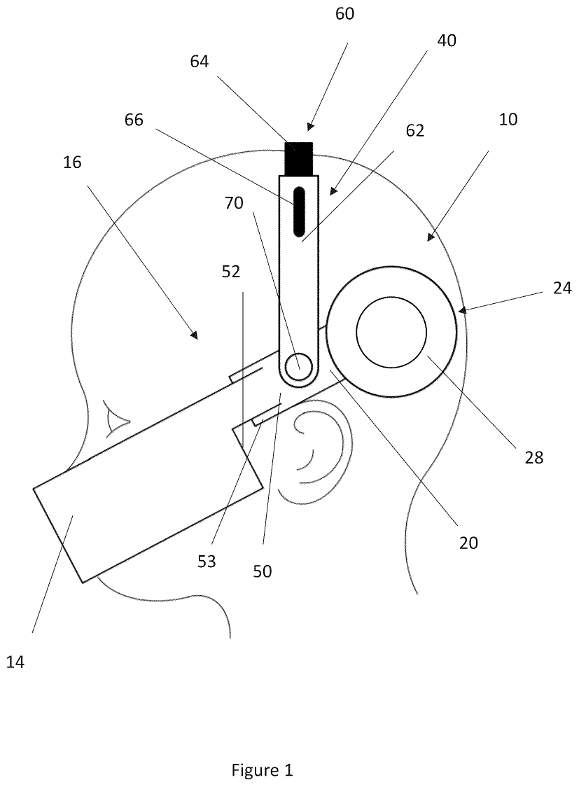

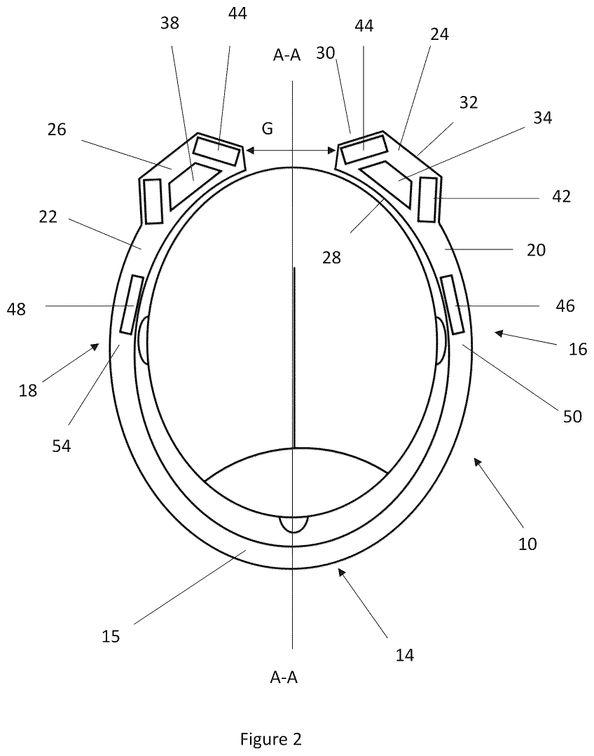

Referring to FIGS. 1 and 2, a wearable air purification system, referred to generally as 10, includes a head worn device which the user supports on their head 12. The head worn device includes an air delivery mask 14 on a front side of the system which covers a user's mouth and bounds an air delivery region 15 of the device. A wearable support, including left and right side supports, 16 and 18 respectively, supports the air delivery mask 14 to the front. The air delivery mask 14 takes the form of an elongate bar which connects at either end with a respective one of the left and right side supports 16, 18. The left and right side supports 16, 18 are generally elongate and extend rearward from the air delivery mask 14, one on either side of the user's head, so that a front section of the side supports, at least, is in line with the elongate bar of the air delivery mask 14. The air delivery mask 14 and the left and right side supports 16, 18 together define a partial loop configuration for circulation of an airflow, as can be seen most clearly in FIG. 2.

Each of the left and right side supports 16, 18 includes a respective rear section 20, 22 which extends rearward of the ear of the user and terminates, at an end remote from the air delivery mask 14, in a respective motor mounting or motor housing 24, 26. Referring to just the left side of the system as visible in FIG. 1, the motor housing 24 includes a generally circular base region 28 which contacts the user's head, rearward of the user's ear, and a tapered portion 30 which extends outwardly from the circular base region 28, away from the user's head 12, towards a flat top 32 of the motor housing 24.

A left hand electric motor unit 34 is mounted within the left hand motor housing 24, the motor unit 34 including a motor and a motor-driven impeller which are operable to drive an air flow through the air flow path defined within the left side support 16 and onwards to the air delivery mask region 15.

The right hand side of the device 10 is the same as the left hand side and includes a right hand motor unit 38 mounted within the right hand housing 26. The right hand motor unit 38 serves to generate an airflow through the right hand side of the device 10 towards to air delivery region 15.

The wearable support further includes a support device in the form of an arcuate headband 40 (as shown in FIG. 1) which spans the user's head 12 between the left side support 16 and the right side support 18, as described further below. The headband 40 is not an essential part of the device and may not be required for some wearers, although if provided it means the device can be more securely supported on the user's head. The head band 40 may be detachable from the device 10.

Referring also to FIG. 2, the left hand motor housing 24 also houses a filter 42, arranged concentrically with the motor unit 34, through which air is drawn into the left hand air flow path by the motor unit 34. An equivalent filter 44 is mounted within the right hand motor housing 26. The filters 42, 44 are situated upstream of the associated motor unit 34, 38 in the air flow paths and as such may be referred to as “pre-filters” (i.e. pre-motor filters). A respective battery 46, 48 is also provided in each of the left and right side supports 16, 18 of the device to deliver power to the associated motor unit 34, 38. The headband 40 has been removed from the illustration shown in FIG. 2, for the sake of clarity. A central front-to rear axis A-A of the user's head 12 is identified in FIG. 2 and it can be seen that the motor unit 34, 38 are mounted symmetrically relative to the axis, each displaced to one side of the axis A-A so that the motor housings 24, 26 define a gap G between them at the rear of the user's head 12.

In some embodiments a post-filter stage (not shown) may also be incorporated into each of the motor housings 24, 26. This may take the form of a filter located downstream of the motor unit 24, 26 to provide a second stage filtration to air drawn into the air flow path by the motor unit (i.e. a post filter). The provision of the pre-filter protects the associated motor from damage due to dust and particulate matter drawn into the device with an airflow, and the post filter ensures any particulate matter which passes through the motor does not reach the air delivery region.

The left and right side air flow paths are defined internally within the left and right side supports 16, 18 and provide a communication path for airflow between the respective motor unit 34, 38 and the air delivery region 15. The air flow paths on each side of the device therefore come together in the air delivery region 15 to deliver clean, filtered air to the wearer of the device from the motor units 34, 38 on both sides.

As seen in the side view in FIG. 1, the left side support 16 includes a bridge section 50 which rests on top of the user's ear when the device 10 is supported on the head 12. The left side bridge section 50 defines, in part, a recess in the side support 16 which ensures the ear of the user is exposed when the device is worn. The recess is bounded by a front face 54 which extends perpendicularly downwards from the bridge section 50 towards the lower edge of the side support 16 and an upper face 53 defined by a lower surface of the bridge section 50.

Likewise, on the other side of the device, the right side support 18 includes a right side bridge region 52 which defines, in part, a recess to expose the right side ear. Because the side supports 16, 18 on each side are shaped to expose the user's ears, the hearing of the user is not impaired when wearing the device 10. Furthermore, as the motor units 34, 38 associated with each of the side supports 16, 18 are mounted rearward of the user's ears, and remote from the ears, audible noise of the motor units 34, 38 when is use is not prominent to the user. This provides a significant advantage over known wearable purification systems where the motors are located in an ear covering which locates over the ear in the manner of an audio earpiece.

A further feature of the invention is its adaptability for wear by different users. If provided, and as shown in FIG. 1, the headband 40 also includes an adjuster 60 which allows the span length of the headband 40 to be adjusted depending on the size of the head on which the device is worn. In this case the headband 40 includes left and right side sections (only the left hand headband section 62 is visible in FIG. 1) which are connected together by an adjustable upper section 64 which extends over the uppermost surface of the user's head 12. Each side section 62 extends downwardly from the upper section 64 and includes an elongate recess 66 which receives a portion of the upper section 64. One end of the upper section 64 is slidable within the recess 66 in the left side section and the other end of the upper section 64 is slidable within the recess in the right side section so as to adjust the exposed length of the upper section 64, depending on the extent to which the ends of the upper section 64 are received in the recesses 64, thereby varying the headband span length over the head 12. This provides a convenient means of adjusting the size of the wearable support, depending on who is to wear the device.

It can be seen that the lower end of the side section 62 is coupled to the left side support 16 at a movable coupling 70 to allow the position of the headband 40 on the head to be adjusted, back and forth, through pivotal movement about the coupling 70. This provides an additional adjustment feature to accommodate different head shapes and sizes and comfort requirements. It also means that the headband 70 may be pivotally mounted with respect to the left and right side supports 16, 18 so that the headband can fold completely forwards into a compact, stowed configuration, where the headband 40 aligns with the air flow channel of the left and right side supports 16, 18, when the device is not being worn.

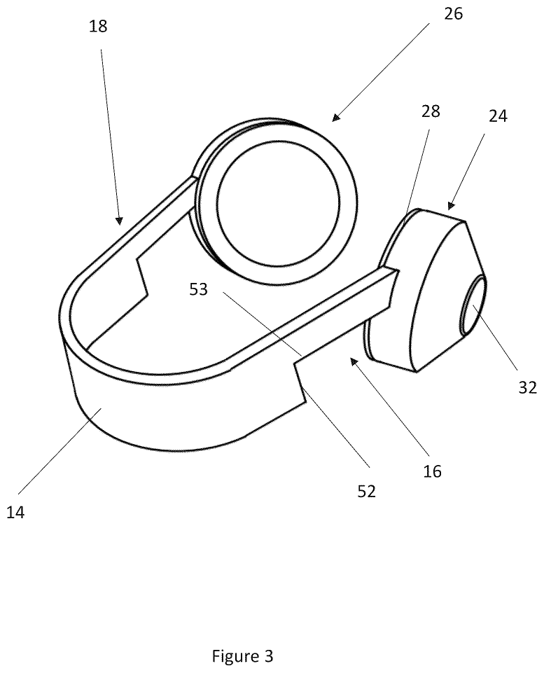

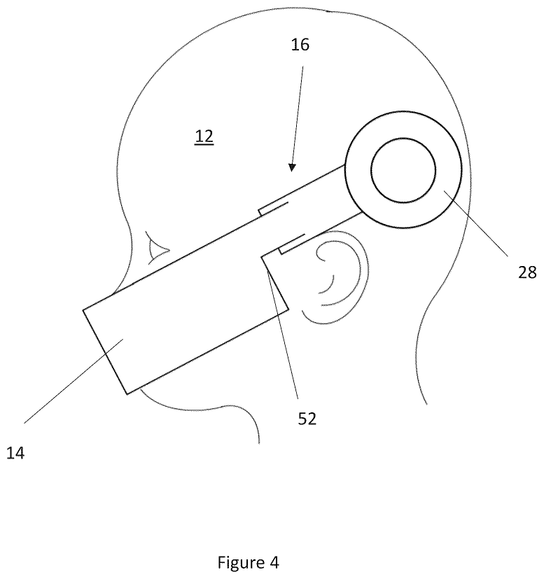

Other means of adjustment are envisaged for the headband 40 including elasticated headbands which adjust to the size of the user's head. FIGS. 3 and 4 show an embodiment in which similar parts to those shown in FIGS. 1 and 2 are labelled with the same reference numbers, but in which the headband 40 is removed altogether.

The air delivery mask 14 and the left and right side supports 16, 18 may be separate parts which are connected together to form the U-shaped device configuration as clearly seen in FIGS. 2 and 3. In other embodiments, the left and right side supports 16, 18 may be integrally formed with the air delivery mask 14 so that the whole air flow path between the motor unit (34 or 38) and the air delivery mask 14 is defined within a single and integrally formed U-shaped device.

In further embodiments (not shown), the left and right side supports 16, 18 may be slidably mounted relative to the air delivery mask 14 so that the front-to-rear length of the device is variable. This provides the advantage that the device can be adjusted for different head sizes, depending on the user.

In other embodiments (not shown), the gap G to the rear of the user's head may be replaced with a connection between the motor housings 24, 26 at the ends of the left and right side supports 16, 18, or by integrally forming the left and right side supports 16, 18, including the motor housings 24, 26, as one piece. In this case the air delivery mask 14 and the side supports 16, 18 define a complete loop configuration to completely encircle around the full circumference of the user's head.

It is one benefit of the invention that the motor units 34, 38 for driving an airflow through the device are mounted remote from the ears, as opposed to being mounted over the ears as in a known ‘headphone style’ arrangement. The motor units 34, 38 produce an audible noise in operation and so mounting them in a position displaced from the ears, and from the opening into the ear canal, provides the benefit that there is limited or no impairment to the user's hearing due to the noise from motor operation. An additional benefit is achieved through the use of two motors 34, 38 located at symmetric positions to the rear of the head, as the weight balance from the motor units is better for the user compared to a single, centrally mounted motor unit. In addition, the air flows that are generated through the air flow paths on each side of the device are suitably balanced. Also, by using two motor units, each can have a reduced power requirement whilst achieving the same airflow rate through the air flow path as that of a single motor unit.

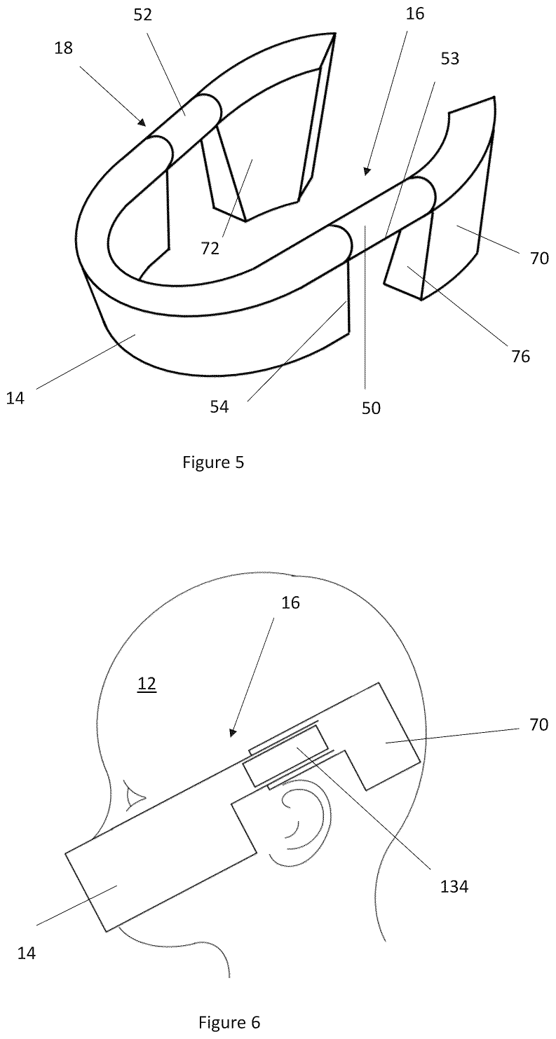

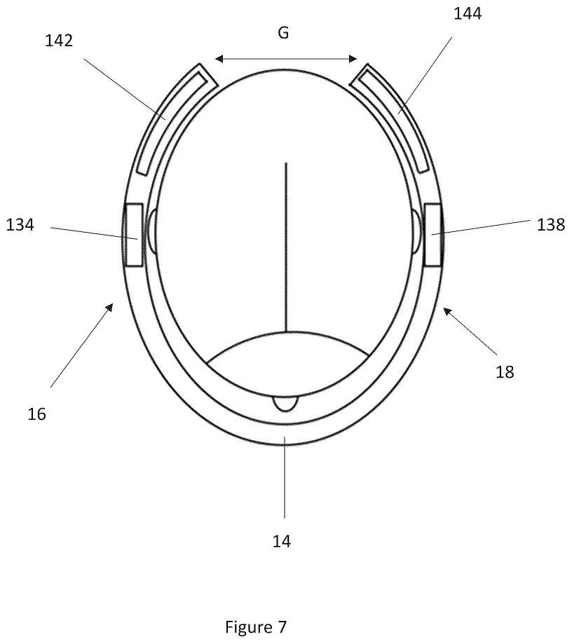

Referring to FIGS. 5 to 7, in an alternative embodiment the motors 134, 138 are moved forwards from the rear of the device and are mounted within an associated one of the bridge sections 50, 52 in the side supports 16, 18, hence occupying a position closer to the air delivery mask 14. In this embodiment the bridge sections 50, 52 therefore define the motor housings of the device (the motors are not visible in FIG. 5). Correspondingly, a rear side head section of the side support is modified to remove the motor housings of FIG. 1 and, instead, the rear side head section on both sides (identified as 70 and 72 in FIG. 5) is shaped to accommodate a corresponding filter 142, 144 associated with the motor 134, 138. The filters 142, 144 can be relatively flat components and sit conveniently within the rear side head sections 70, 72. The internal surfaces of the rear side head sections 70, 72 are profiled to correspond to the surface shape of the user's head 12. The outer surfaces of the rear side head sections 70, 72 are also profiled (e.g. curved) for aesthetic effect.

Each bridge section 50, 52 defines the upper face 53 of a recess between the front and rear sections of the side supports 16, 18. The front face 54 of the recess extends downwards perpendicularly from the bridge section, as does a rear face 76 of the recess which is defined by the rear section of the side support 16.

A gap, G, is defined between the rear face of each of the rear sections to leave an exposed area at the back of the user's head.

Although in FIGS. 5 to 7 the motors are mounted closer to the ears than in the previous embodiments, there is still a notable noise reduction compared to devices in which the motors are mounted over the ear. This embodiment also provides a particularly streamlined and comfortable device for the user to wear as the motor housings at the rear of the user's head are not required.

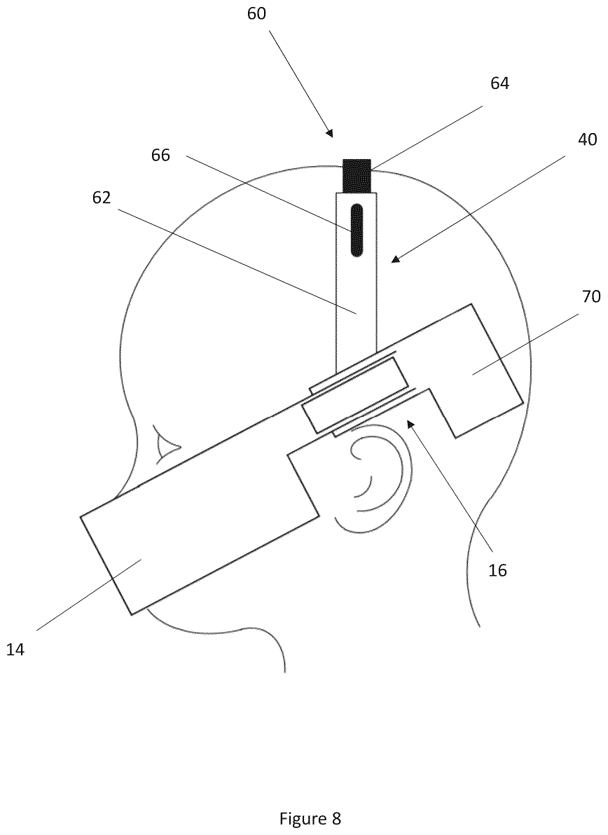

Referring to FIG. 8, the device including the motors within the bridge sections of the side supports may be provided with a headband, as described previously, which may include an adjuster 60, 62, 64, 66 to vary the span length of the headband 40.

In a further embodiment of the invention, as shown in FIG. 9, the wearable purification system may include audio headphones including left and right side earpieces 90, 92 for delivering sound to the user. Each earpiece 90, 92 includes audio equipment in the form of a speaker assembly so as to provide audio play to function as headphones. Each earpiece 90, 92 is mounted to a respective one of the side supports 16, 18 and attaches to the headband 40 in a conventional manner. Each of the motor units 234, 238 may be mounted in motor housing 250, 252 forming part of an extension at the rear of the associated side support 16, 18. The motor housing 250, 252 takes the form of a tubular extension to the side support which sits rearward of the associated earpiece 90, 92. Again, this embodiment provides the advantage that the motor is housed remote from and rearward of the ear when the device 10 is worn on the user's head.

In the aforementioned embodiments it is assumed that the air is sucked in through both motor units 234, 238 and is drawn through the air flow path on both sides of the device towards the air delivery mask. However, it is also possible to configure one of the motors so as to suck air out of the air flow path on one side so that one motor (e.g. the right hand motor) draws air into the air flow path on one side, filtering air before it reaches the air delivery region, and the other motor (e.g. the left hand motor) draws air out of the air flow path on the other side, expelling clean air from the device. It is therefore possible to configure the motor units 234, 238 so that the airflow is either drawn towards the air delivery region or away from the air delivery region 15. Arranging one motor unit to draw air in, and one motor unit to draw air out has benefits for virus control as it ensures that the user's breath is filtered before being exhausted into the environment. In this way, if a user is unwell, transmission of the virus is significantly reduced.

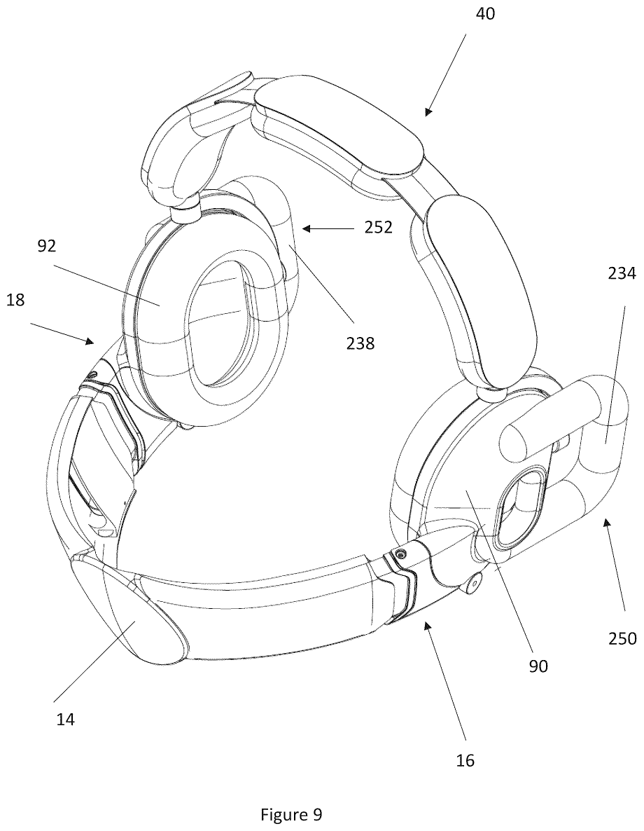

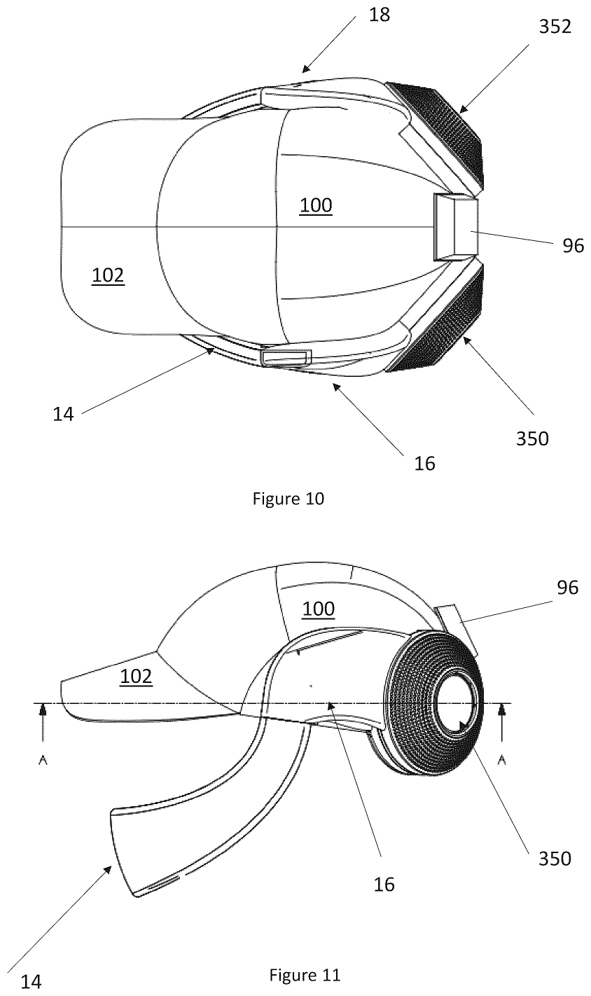

In a further alternative embodiment, as shown in FIGS. 10 and 11, the wearable purification system is a head worn device including a wearable support in the form of a cap or hat. The cap includes a head cover portion 100 which covers a substantial portion of an upper region of the wearer's head and a peaked portion 102 which projects forward from the head cover portion 100 on the front side of the cap, in a conventional manner. The left and right side supports 16, 18 reside beneath the head cover portion 100 and connect integrally with the air delivery mask 14 to form a U-shaped configuration around the face of the wearer. In other embodiments, the side supports 16, 18 may be separate parts from the air delivery mask 14, with the parts being connected together to form the U-shaped configuration.

Each of the left hand and right hand motor units (not visible) is located within a respective left or right side motor housing, 350, 352 respectively, mounted to the rear of a respective one of the left and right side supports 16, 18 so that, when the cap is worn, the motor housings 350, 352 rest against the wearer's head, in a position behind the ears. The motor housings 350, 352 may be secured to or integrally connect with the lower edge of the head cover portion 100 on its rear side so that they form an integral part with the head cover portion 100. Alternatively, the motor housings 350, 352 may be formed from a different material to the head cover portion 100 and may be attached securely to the head cover portion 100 by suitable fixing means.

A housing 96 is also mounted on a rear side of the head cover portion 100 between the left and right hand motor housings 350, 352. The housing 96 spaces the left and right hand motors housings 350, 352 apart so that there is a gap between them. The housing 96 contains electronic circuitry (not shown) including a battery to provide power for both of the motor units within the motor housings 350, 352.

As in previously described embodiments, when the device is worn the two motor housings 350, 352 are located at symmetric positions to the rear of the head which benefits the weight balance for the user compared to having a single, centrally mounted motor housing. In addition, the air flows that are generated through the air flow paths on each side of the wearable device are suitably balanced. The use of two motor units means that each can have a reduced power requirement whilst achieving the same airflow rate through the air flow path as that of a single motor.

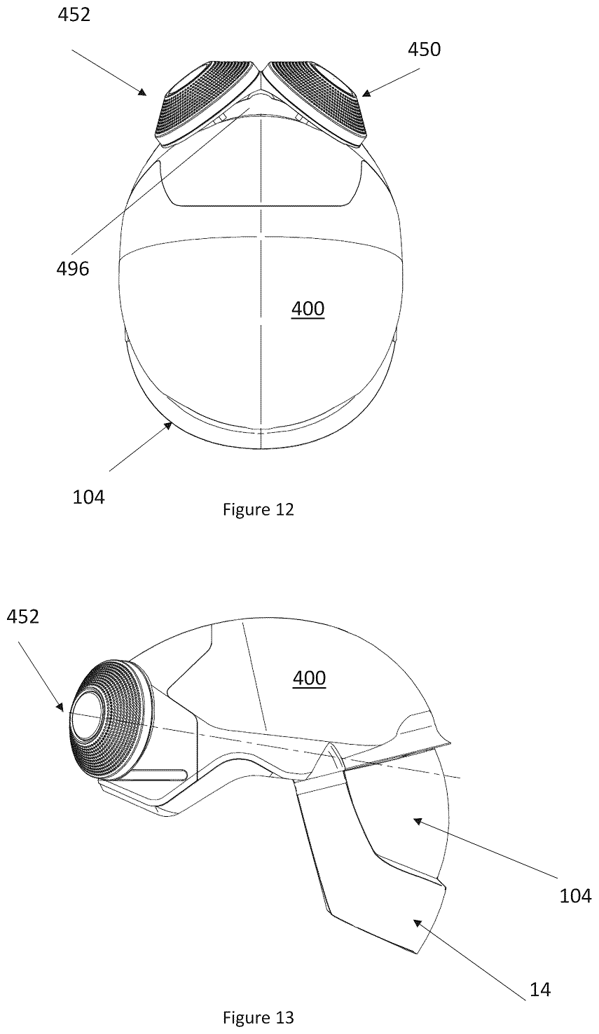

Referring to FIGS. 12 and 13, in a further alternative embodiment the wearable purification device is a head worn device including a wearable support in the form of a helmet (for example a safety helmet or a helmet worn such as that worn when riding a motorcycle). The helmet includes a head cover portion 400 which covers a substantial portion of an upper region of the wearer's head, and a visor 104 which locates over the wearer's face when deployed. As in the embodiment in FIGS. 10 and 11, left and right hand motor housings, 450, 452 respectively, are located to the rear of the head cover portion 400 so that they locate against the wearer's head in a position rearward of the ears when the helmet is worn. The motor housings 450, 452 are connected to, or are formed integrally with, the head cover portion 400 on the rear side of the helmet. Each motor housing 450, 452 houses a respective motor unit.

A housing 496 for electronic circuitry including a battery to power the motor units is located centrally at the rear of the device. The motor housings 450, 452 are adjacent to one another on the rear side of the device, and may be touching or very close to one another, rather than being spaced apart. The motor housings 450, 452 are angled such that a cavity is defined between the motor housings 450, 452 and the wearer's head, when the device is worn, which provides accommodation space for the housing 496. In this way the housing 496 is shielded from view and is protected beneath the motor housings 450, 452. The benefits of the aforementioned embodiments, in terms of the balance provided by the symmetric mounting of the motor housings rearward of the wearer's ears, and the positioning of the motor units away from the wearer's ears, are also realised in the embodiment of the invention in FIGS. 12 and 13, as for previous embodiments.

It will be appreciated that various changes and modifications can be made to the present invention without departing from the scope of the present application.

1. A wearable air purification system comprising:
a wearable support configured to be supported on a head of a user, and
an air delivery mask which is shaped to at least partially bound an air delivery region and to deliver a flow of air to the air delivery region;
wherein the wearable support includes a left side support and a right side support which support the air delivery mask therebetween; and a left side motor and a right side motor configured to drive a respective left or right side air flow towards or away from the air delivery region, each of the left and right side motors being mounted within a respective left or right side motor mounting on a respective one of the left and right side supports so that, when the wearable support is supported on the head in use, the motors sit rearward of or above the user's ears.

2. The wearable air purification system as claimed in claim 1, wherein each of the left and right side supports includes an elongate side portion which extends rearwards from the air delivery mask.

3. The wearable air purification system as claimed in claim 1, wherein the air delivery mask takes the form of an elongate bar.

4. The wearable air purification system as claimed in claim 2, wherein the air delivery mask takes the form of an elongate bar and wherein the elongate side portions are arranged in line with the elongate bar of the air delivery mask.

5. The wearable air purification system as claimed in claim 1, wherein each of the left and right side supports includes a side head portion which extends over a portion of the user's head rearward of the user's ears, when the wearable support is supported on the head in use.

6. The wearable air purification system as claimed in claim 1, wherein the wearable support further includes a support device which has first and second ends, and wherein a respective one of the left and right side supports connects with a respective one of the first and second ends.

7. The wearable air purification system as claimed in claim 6, wherein the support device is a headband which spans the top of the head in use.

8. The wearable air purification system as claimed in claim 1, wherein each of the left and right side supports defines a respective bridge section which sits above a respective ear of the user, when the wearable support is supported on the head in use.

9. The wearable air purification system as claimed in claim 8, wherein each of the left and right side bridge sections defines a respective one of the motor housings so that the motors locate above a respective ear of the user, when the wearable support is supported on the head in use.

10. The wearable air purification system as claimed in claim 1, wherein each of the left and right side motor housings is positioned remote from the air delivery region so as to locate rearward of the ears of the user when the wearable support is supported on the head in use.

11. The wearable air purification system as claimed in claim 10, wherein the motor housings define a gap between them at the rear of the user's head, when the wearable support is supported on the head in use.

12. The wearable air purification system as claimed in claim 1, wherein the left and right side supports connect to one another, or are formed integrally with one another, at the rear of the user's head so as to define a closed loop structure with the air delivery mask.

13. The wearable air purification system as claimed in claim 1, wherein each of the left and right side supports includes a recess which exposes a respective left or right ear of the user when the wearable support is supported on the head in use.

14. The wearable air purification system as claimed in claim 8, wherein each of the left and right side bridge sections includes a recess which exposes a respective left or right ear of the user when the wearable support is supported on the head in use.

15. The wearable air purification system as claimed in claim 1, further comprising an audio device mounted on each of the left and right side supports, each of the audio devices being configured to deliver audible sound to a respective ear of the user.

16. The wearable air purification system as claimed in claim 1, wherein the air delivery mask is slidably mounted relative to the left and right side supports.

17. The wearable air purification system as claimed in claim 1, wherein each of the left and right motor housings houses a motor-driven impeller to deliver a respective one of the left or right side air flows to or away from the air delivery region.

18. The wearable air purification system as claimed in claim 1, further comprising a filter associated with each of the left and right side motors for filtering the air flow.

19. The wearable air purification system as claimed in claim 18, wherein each filter is located in the motor housing together with the associated motor.

20. The wearable air purification system as claimed in claim 5, further comprising a filter associated with each of the left and right side motors for filtering the air flow, wherein each of the filters is located within the head portion.

21. The wearable purification system as claimed in claim 1, wherein one of the left and right side motors is configured to drive the airflow towards the air delivery region and the other of the left and right side motors is configured to suck the air flow away from the air delivery region.

22. The wearable purification system as claimed in claim 1, wherein both of the left and right side motors are configured to drive the airflow towards the air delivery region.

23. The wearable purification system as claimed in claim 1, wherein the wearable support includes a head portion for covering a portion the user's head.

24. The wearable purification system as claimed in claim 23, wherein the head portion forms a part of a hat, a helmet or a cap.
